(19) United States
(12) Patent Application Publication
(10) Pub. No.: US 2020/0082316 A1
(43) Pub. Date: Mar. 12, 2020

(54) COGNITIVE HANDLING OF WORKLOAD REQUESTS

(71) Applicant: INTERNATIONAL BUSINESS MACHINES CORPORATION, ARMONK, NY (US)

(72) Inventors: Aly MEGAHED, San Jose, CA (US); Ramani ROUTRAY, San Jose, CA (US); Samir TATA, Cupertino, CA (US)

(21) Appl. No.: 16/129,042

(22) Filed: Sep. 12, 2018

(51) Int. Cl. G06Q 10/06; G06N 99/00; G06F 9/50; G06N 7/00

(52) U.S. Cl. CPC G06Q 10/06312; G06N 7/00; G06F 9/505; G06N 99/005

(57) ABSTRACT

A method for cognitive handling of workload requests in a Cloud environment including data centers (DCs) may include operating a processor and associated memory to obtain historical resource consumption data of historical workloads of the DCs. The method may also include operating the processor to generate a trained prediction model based upon the historical resource consumption data, obtain current resource consumption data of current workloads of the DCs, and operate the trained prediction model based upon the current resource consumption data to generate predicted future resource consumption data for future workloads of the DCs. The method may also include operating the processor to receive a workload request, and generate a recommended handling of the workload request based upon the predicted future resource consumption data.

### BACKGROUND

The present invention relates to computer workload request distribution, and more specifically, to cognitive handling of workload requests. The process of handling workload requests by cloud providers may typically include information technology (IT) capacity requirement gathering, solution design, and delivery/deployment into specific data centers (DCs). A service level agreement (SLA) for IT services may set forth requirements for a certain threshold of resource availability (e.g., speed and capacity). Available resources at a given DC may vary over time making predicting available resources increasingly difficult. Incoming workload requests also vary over time also making predicting available resources at a given DC increasingly difficult. Thus, fulfilling SLA requirements may also be relatively difficult thus subjecting the cloud or service provider to potential penalties.

### SUMMARY

A method for cognitive handling of workload requests in a Cloud environment including a plurality of data centers (DCs) may include operating a processor and associated memory to obtain historical resource consumption data of historical workloads of the plurality of DCs and generate a trained prediction model based upon the historical resource consumption data. The method may also include operating the processor to obtain current resource consumption data of current workloads of the plurality of DCs, and operate the trained prediction model based upon the current resource consumption data to generate predicted future resource consumption data for future workloads of the plurality of DCs. The method may also include operating the processor to receive a workload request, and generate a recommended handling of the workload request based upon the predicted future resource consumption data.

Generating the recommended handling may be based upon at least one of an allocated DC for the workload request, estimated revenues, a payment penalty for assignment to a DC different than the allocated DC, a constraint on a future workload allocation, a current capacity of each resource type at each DC, and resource costs, for example.

The trained prediction model may include a time-series model, and the historical resource consumption data may include time-stamped workload consumption data for different workloads, for example. The trained prediction model may include a machine learning regression model, and the historical resource consumption data may include metadata characterizing each workload, for example.

Generating the trained prediction model may include generating a respective trained prediction model for each different workload resource consumption type from among a plurality of different workload resource consumption types. Generating the recommended handling may include operating a mixed integer programming model to optimize the recommended handling, for example. A constraint of the mixed integer programming model may include one of a dynamic of capacity increase, resource consumption, and future workload prediction.

The recommended handling may include one of allocating the workload request to a requested DC without changing its capacity, allocating the workload request to its requested DC with changing its capacity, allocating the workload request to a different DC than the requested DC, and rejecting the workload request, for example.

Generating the recommended handling may be based upon a tradeoff between a cost of increasing resources in a requested DC for the workload request, and re-allocating the workload request to a different DC than the requested DC. Generating the recommended handling may be based upon an optimization of a cost of increasing a DC capacity, a penalty for over-utilization, and a revenue for handling the workload request.

The historical resource consumption data may include structured historical resource consumption data and unstructured historical resource consumption data. The trained prediction model may include a first prediction model based upon the structured historical resource consumption data, a second prediction model based upon the unstructured historical resource consumption model, and a combined model configured to provide a final output based upon at least one of an aggregation of an output of each of the first and second models and a building of a model based upon the output of each of the first and second models, for example.

The historical resource consumption data may include structured and unstructured historical resource consumption data. The processor may be operated to structure the unstructured historical resource consumption data to generate newly structured historical resource consumption data, and the processor may be operated to generate the trained prediction model based upon both the structured historical resource consumption data and the newly structured historical resource consumption data, for example.

A system aspect is directed to a system for cognitive handling of workload requests in a Cloud environment that includes a plurality of data centers (DCs). The system may include a processor and a memory associated therewith. The processor may be configured to obtain historical resource consumption data of historical workloads of the plurality of DCs, and generate a trained prediction model based upon the historical resource consumption data. The processor may be configured to obtain current resource consumption data of current workloads of the plurality of DCs, operate the trained prediction model based upon the current resource consumption data to generate predicted future resource consumption data for future workloads of the plurality of DCs, and receive a workload request. The processor may also be configured to generate a recommended handling of the workload request based upon the predicted future resource consumption data.

A computer readable medium aspect is directed to a computer readable medium for cognitive handling of workload requests in a Cloud environment that includes a plurality of data centers (DCs). The computer readable medium includes computer executable instructions that when executed by a processor cause the processor and associated memory to perform operations. The operations may include obtaining historical resource consumption data of historical workloads of the plurality of DCs and generating a trained prediction model based upon the historical resource consumption data. The operations may also include obtaining current resource consumption data of current workloads of the plurality of DCs, and operating the trained prediction model based upon the current resource consumption data to generate predicted future resource consumption data for future workloads of the plurality of DCs. The operations may further include receiving a workload request, and generating a recommended handling of the workload request based upon the predicted future resource consumption data.

### BRIEF DESCRIPTION OF THE DRAWINGS

FIG. 1 is a schematic diagram of a system for cognitive handling of workload requests in accordance with an embodiment.

FIG. 2 is a schematic block diagram of a portion of the system of FIG. 1.

FIG. 3 is a flow chart illustrating cognitive handling of workload requests according to an embodiment.

FIG. 4 is another flow diagram illustrating cognitive handling of workload requests according to an embodiment.

FIG. 5 depicts a cloud computing environment according to an embodiment.

FIG. 6 depicts abstraction model layers according to an embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

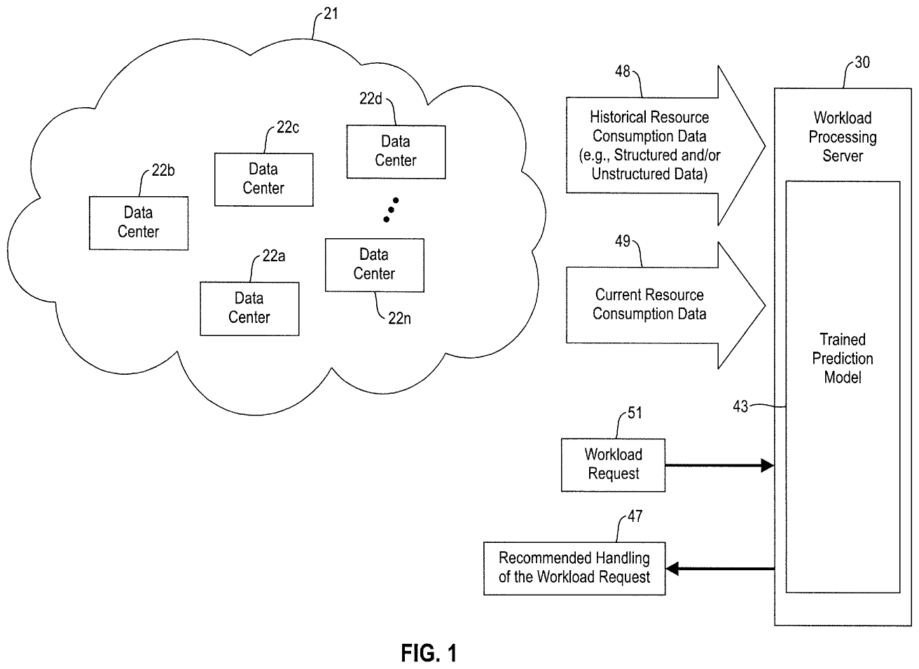

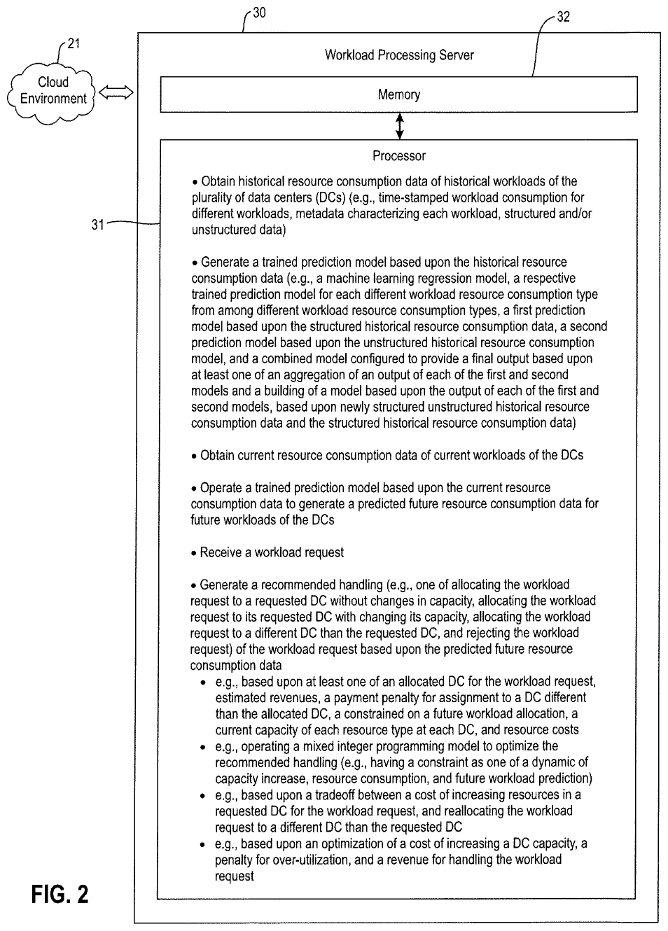

Referring initially to FIGS. 1-2, a system 20 for cognitive handling of workload requests 51 in a Cloud environment 21 will now be described. The Cloud environment 21 includes data centers (DCs) 22a-22n. Those skilled in the art will recognize that DCs may include one or more computers or servers that process computer requests or provide services. DCs 22a-22n may be used, for example, to fulfill service level agreement (SLA) requirements for an information technology (IT) agreement (e.g., backend or cloud processing). The DCs 22a-22n may be geographically spaced apart and communicatively coupled by one more network, for example, the Internet, to define the Cloud environment 21.

The system 20 also includes a workload processing server 30 that includes a processor 31 and a memory 32 associated with the processor. While functions of the workload processing server 30 will be described herein, those skilled in the art will appreciate that the functions of the workload processing server are performed based upon cooperation of the processor 31 and the memory 32.

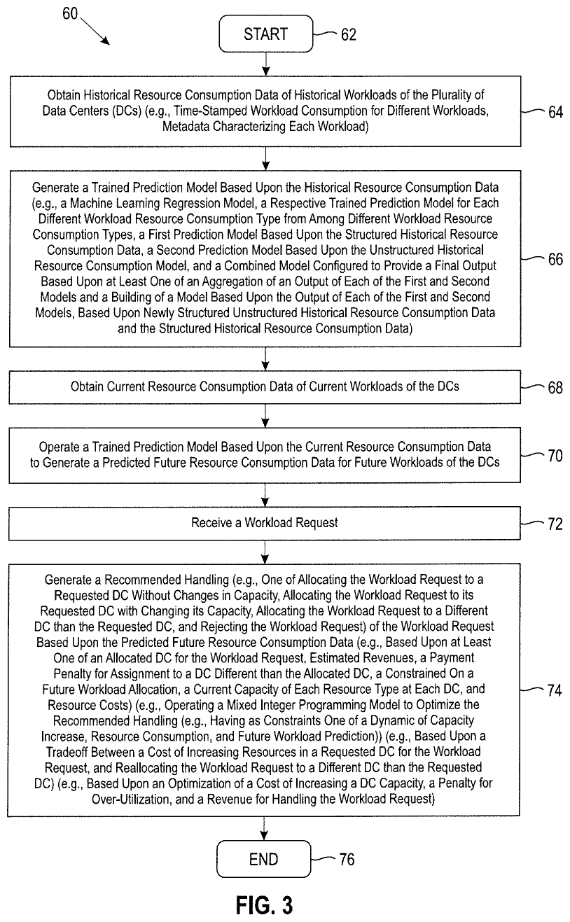

Referring now additionally to the flowchart 60 in FIG. 3, beginning at Block 62, operations of the workload processing server 30 with respect to cognitive handling of workload requests will now be described. The workload processing server 30 is operated, at Block 64, to obtain historical resource consumption data 48 or historical workloads of the DCs 22a-22n. The historical resource consumption data 48 may include structured and/or unstructured (e.g., text, image, video, and/or audio data) historical resource consumption data.

The workload processing server 30 performs a prediction model training 44 to generate a trained prediction model 43 based upon the historical resource consumption data 48 (Block 66). More particularly, the trained prediction model 43 may be generated by generating a respective trained prediction model for each different workload resource consumption type from among different workload consumption types. The trained prediction model 43 may be generated based upon either or both of the structured and unstructured historical resource consumption data 48. In other words, in some embodiments, the trained prediction model 43 may include a first prediction model based upon the structured historical resource consumption data, a second prediction model based upon the unstructured historical resource consumption model, and a combined model configured to provide a final output based upon at least one of an aggregation of an output of each of the first and second models and a building of a model based upon the output of each of the first and second models, for example. In some embodiment, the unstructured historical resource consumption data be structured to generate newly structured historical resource consumption data, and the trained prediction model 43 may be based upon both the structured historical resource consumption data and the newly structured historical resource consumption data, for example.

The trained prediction model 43 may include a time-series model or a multi-variable regression model, for example. When, for example, the trained prediction model 43 includes a time-series model, the historical resource consumption data 48 may include time-stamped workload consumption data for different workloads. In some embodiments, the trained prediction model 43 may be a hybrid model, for example, based upon a time-series model and a multi-variable regression model.

In some implementations or embodiments, the trained prediction model 43 may include a machine learning regression model. When the trained prediction model 43 includes a machine learning regression model, the historical resource consumption data 48 includes metadata characterizing each workload.

The workload processing server 30 obtains current resource consumption data 49 of current workloads of the DCs 22a-22n (Block 68). At Block 70, the workload processing server 30 operates the trained prediction model 43 based upon the current resource consumption data 49 to generate predicted future resource consumption data 41 for future workloads of the DCs 22a-22n. At Block 72, the workload processing server 30 receives a workload request 51.

The workload processing server 30 generates a recommended handling 47 of the workload request based upon the predicted future resource consumption data 41 (Block 74). The recommended handling 47 may be based upon one or more of an allocated DC 22a-22n for the workload request 51, estimated revenues, a payment penalty for assignment to a DC different than the allocated DC, a constraint on a future workload allocation, a current capacity of each resource type at each DC, and resource costs. The recommended handling 47 may also be based upon a tradeoff between a cost of increasing resources in a requested DC 22a-22n for the workload request 51, and re-allocating the workload request to a different DC than the requested DC. The recommended handling 47 may also be based upon an optimization of a cost of increasing a DC capacity, a penalty for over-utilization, and a revenue for handling the workload request 51.

The recommended handling 47 may include one of allocating the workload request 51 to a requested DC 22a-22n without changing its capacity allocating the workload request to its requested DC with changing its capacity, allocating the workload request to a different DC than the requested DC, and rejecting the workload request. To optimize the recommended handling 47, in some implementations, the recommended handling may be generated by operating a mixed integer programming model. Operations end at Block 76.

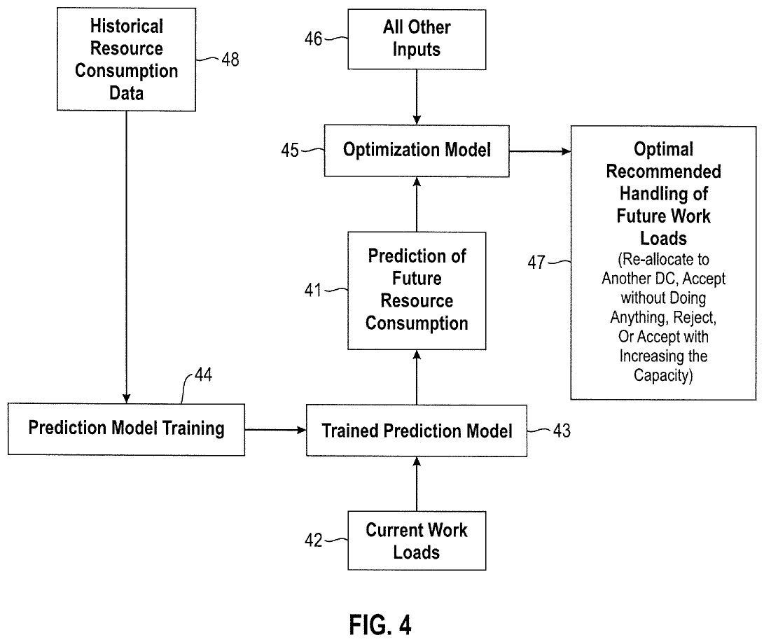

Referring now to FIG. 4, further details of the cognitive handling of workload requests 51 will now be described. With respect to the prediction of future resource consumption 41 of current workloads 42, a time-series or a multi-variable regression model 43 is to be trained 44 on the historical resource consumption data 48 in order to predict the future evolution of workloads. That is, if the historical training data 48 includes only time-stamped work load consumptions for different workloads, then time-series models (e.g., an autoregressive integrated moving average (ARIMA) model) can be used to predict the future evolution of current workloads.

With respect to an ARIMA model, a prototype ARIMA model was built for each cluster. The ARIMA model was trained on all given data except last two months, then tested on last two months to validate its accuracy. Then, the ARIMA model was trained on all data and used to forecast/predict the utilization for next nine months. As will be appreciated by those skilled in the art, the ARIMA model may be considered a relatively powerful model for time-series forecasting whenever there are autocorrelations between data at different times.

Data transformation and model parameterization were performed to be able to use ARIMA. The data was transformed so that stationarity assumption holds, and experimentation with model parameters was done to find the best model to use. Then, after forecasting the utilization at the cluster level, the needed capacity was aggregated at the DC level, assuming that any cluster must be at most 50% utilized. For example, suppose the CPU utilization was 50% of a CPU capacity of 600. Then, suppose that the model predicts the CPU utilization to go up to 93%. Now, that means that 0.93*600=558 will be used.

In order to make sure that adhere to the rule that the cluster is at most 50% utilized, 558*2=1116 CPU is desired. Thus, the needed added capacity is 1116−600=516. It should be noted that the 50% is a parameter for the model, and thus can be any other user-chosen input value.

A separate model is to be built for each workload resource consumption type (CPU, memory, etc.). However, if the historical training data includes meta-data characterizing each workload (type of application (e.g., processing intensive or data intensive), type of user, . . . etc.), then a machine learning regression model can be trained that uses that meta-data and the time stamps as features to predict the evolution of the workload. Again, a separate model is to be built for each resource type.

With respect to the optimal recommendation of how to handle each future workload request or future workloads 47, a mixed integer programming model 45 is to be formulated to come up with the optimal recommendations of how to handle each future workload. The variables of the model are binary. For example, xᵢ is 1 if workload i is to be accepted without increasing any capacities, and 0 otherwise, and yᵢⱼ is 1 if workload i is to be accepted with increasing capacity in DCⱼ and 0 otherwise. Then, in the constraints, only one of these variables will be forced to be 1 (so that only 1 decision per workload is achieved). The tradeoff that is optimized is that if the resources are increased, there is a cost associated, and the resources might then be under-utilized. There is also a cost for re-allocation of workloads to different DCs. Other inputs 46 may be provided to the optimization model 45 to generate the optimal recommendation 47.

Thus, the objective function of the model optimizes the aforementioned trade-off, incorporates costs of increasing capacities, and incorporates penalties paid for over-utilizations and revenues out of handling workloads. The system 20 may be constrained in that the capturing of the dynamics of capacity increases with the different possible decisions for handling the workloads, and the prediction of the evolution of the workloads are put in consideration, and thus the elements that make the system 20 and functions described herein a cognitive approach are thus captured.

Any given constraints also to be captured. For example, some workloads may not be allocated except to the given DC they are allocated to, and thus for these workloads, the decision has to be either allocate them to these DCs or reject them, and thus the decision variables related to re-allocating them are to be set to zero.

As will be appreciated by those skilled in the art, the system 20 advantageously handles workload requests 51 in a cognitive manner by, contrary to prior approaches, taking into account the prediction of variation of resource usage with the current workloads in the cloud environments and taking into account potential future penalties that might be paid to clients for not fulfilling service level agreement (SLA) requirements due to insufficient resource availability. The system 20 also takes into account the evolution of capacity procurement for current DCs. Those skilled in the art will appreciate that prior approaches use a process that is a one-path process in terms of allocating the requests rather than exploring different possibilities, reasoning these possibilities, and optimizing the deployment decisions.

A method aspect is directed to a method for cognitive handling of workload requests 51 in a Cloud environment 21 that includes a plurality of data centers (DCs) 22a-22n. The method includes operating processor 31 and a memory 32 associated therewith to obtain historical resource consumption data 48 of historical workloads of the plurality of DCs 22a-22n, and generate a trained prediction model 43 based upon the historical resource consumption data. The processor 31 is operated to obtain current resource consumption data 49 of current workloads of the plurality of DCs 22a-22n, operate the trained prediction model 43 based upon the current resource consumption data 49 to generate predicted future resource consumption data 41 for future workloads of the plurality of DCs 22a-22n, and receive a workload request 51. The processor 31 is also operated to generate a recommended handling of the workload request 51 based upon the predicted future resource consumption data 41.

A computer readable medium aspect is directed to a computer readable medium for cognitive handling of workload requests 51 in a Cloud environment 21 that includes a plurality of data centers (DCs) 22a-22n. The computer readable medium includes computer executable instructions that when executed by a processor 31 cause the processor and associated memory 32 to perform operations. The operations include obtaining historical resource consumption data 48 of historical workloads of the plurality of DCs 22a-22n and generating a trained prediction model 43 based upon the historical resource consumption data. The operations also include obtaining current resource consumption data 49 of current workloads of the plurality of DCs 22a-22n, and operating the trained prediction model 43 based upon the current resource consumption data to generate predicted future resource consumption data 41 for future workloads of the plurality of DCs. The operations further include receiving a workload request 51, and generating a recommended handling 47 of the workload request based upon the predicted future resource consumption data 41.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

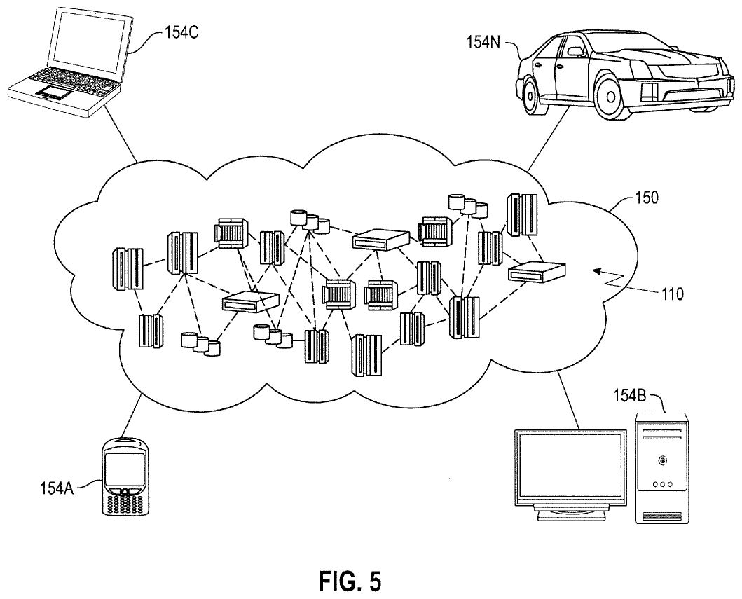

Referring now to FIG. 5, illustrative cloud computing environment 150 is depicted. As shown, cloud computing environment 150 includes one or more cloud computing nodes 110 with which local computing devices used by cloud consumers, such as, for example, personal digital assistant (PDA) or cellular telephone 154A, desktop computer 154B, laptop computer 154C, and/or automobile computer system 154N may communicate. Nodes 110 may communicate with one another. They may be grouped (not shown) physically or virtually, in one or more networks, such as Private, Community, Public, or Hybrid clouds as described hereinabove, or a combination thereof. This allows cloud computing environment 150 to offer infrastructure, platforms and/or software as services for which a cloud consumer does not need to maintain resources on a local computing device. It is understood that the types of computing devices 154A-154N shown in FIG. 5 are intended to be illustrative only and that computing nodes 110 and cloud computing environment 150 can communicate with any type of computerized device over any type of network and/or network addressable connection (e.g., using a web browser).

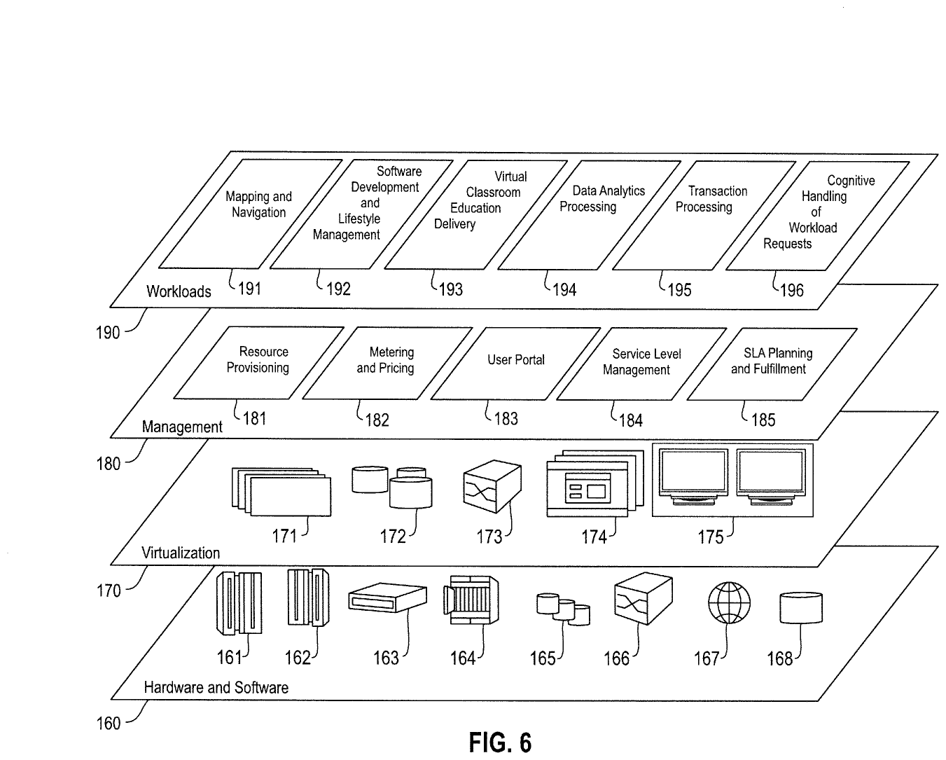

Referring now to FIG. 6, a set of functional abstraction layers provided by cloud computing environment 150 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 160 includes hardware and software components. Examples of hardware components include: mainframes 161; RISC (Reduced Instruction Set Computer) architecture based servers 162; servers 163; blade servers 164; storage devices 165; and networks and networking components 166. In some embodiments, software components include network application server software 167 and database software 168.

Virtualization layer 170 provides an abstraction layer from which the following examples of virtual entities may be provided: virtual servers 171; virtual storage 172; virtual networks 173, including virtual private networks; virtual applications and operating systems 174; and virtual clients 175.

In one example, management layer 180 may provide the functions described below. Resource provisioning 181 provides dynamic procurement of computing resources and other resources that are utilized to perform tasks within the cloud computing environment. Metering and Pricing 182 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 183 provides access to the cloud computing environment for consumers and system administrators. Service level management 184 provides cloud computing resource allocation and management such that required service levels are met. Service Level Agreement (SLA) planning and fulfillment 185 provide pre-arrangement for, and procurement of, cloud computing resources for which a future requirement is anticipated in accordance with an SLA.

Workloads layer 190 provides examples of functionality for which the cloud computing environment may be utilized. Examples of workloads and functions which may be provided from this layer include: mapping and navigation 191; software development and lifecycle management 192; virtual classroom education delivery 193; data analytics processing 194; transaction processing 195; and cognitive handling of workload requests 196.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for cognitive handling of workload requests in a Cloud environment comprising a plurality of data centers (DCs), the method comprising:
operating a processor and associated memory to
obtain historical resource consumption data of historical workloads of the plurality of DCs,
generate a trained prediction model based upon the historical resource consumption data,
obtain current resource consumption data of current workloads of the plurality of DCs,
operate the trained prediction model based upon the current resource consumption data to generate predicted future resource consumption data for future workloads of the plurality of DCs,
receive a workload request, and
generate a recommended handling of the workload request based upon the predicted future resource consumption data.

2. The method of claim 1 wherein generating the recommended handling is based upon at least one of an allocated DC for the workload request, estimated revenues, a payment penalty for assignment to a DC different than the allocated DC, a constraint on a future workload allocation, a current capacity of each resource type at each DC, and resource costs.

3. The method of claim 1 wherein the trained prediction model comprises a time-series model, and wherein the historical resource consumption data comprises time-stamped workload consumption data for different workloads.

4. The method of claim 1 wherein the trained prediction model comprises a machine learning regression model, and the historical resource consumption data comprises metadata characterizing each workload.

5. The method of claim 1 wherein generating the trained prediction model comprises generating a respective trained prediction model for each different workload resource consumption type from among a plurality of different workload resource consumption types.

6. The method of claim 1 wherein generating the recommended handling comprises operating a mixed integer programming model to optimize the recommended handling.

7. The method of claim 6 wherein a constraint of the mixed integer programming model comprises one of a dynamic of capacity increase, resource consumption, and future workload prediction.

8. The method of claim 1 wherein the recommended handling comprises one of allocating the workload request to a requested DC without changing its capacity, allocating the workload request to its requested DC with changing its capacity, allocating the workload request to a different DC than the requested DC, and rejecting the workload request.

9. The method of claim 1 wherein generating the recommended handling is based upon a tradeoff between a cost of increasing resources in a requested DC for the workload request, and re-allocating the workload request to a different DC than the requested DC.

10. The method of claim 1 wherein generating the recommended handling is based upon an optimization of a cost of increasing a DC capacity, a penalty for over-utilization, and a revenue for handling the workload request.

11. The method of claim 1 wherein the historical resource consumption data comprises structured historical resource consumption data and unstructured historical resource consumption data; and wherein the trained prediction model comprises a first prediction model based upon the structured historical resource consumption data, a second prediction model based upon the unstructured historical resource consumption model, and a combined model configured to provide a final output based upon at least one of an aggregation of an output of each of the first and second models and a building of a model based upon the output of each of the first and second models.

12. The method of claim 1 wherein the historical resource consumption data comprises structured and unstructured historical resource consumption data; wherein the processor is operated to structure the unstructured historical resource consumption data to generate newly structured historical resource consumption data; and wherein the processor is operated to generate the trained prediction model based upon both the structured historical resource consumption data and the newly structured historical resource consumption data.

13. A system for cognitive handling of workload requests in a Cloud environment comprising a plurality of data centers (DCs), the system comprising:
a processor and a memory associated therewith, the processor configured to
obtain historical resource consumption data of historical workloads of the plurality of DCs,
generate a trained prediction model based upon the historical resource consumption data,
obtain current resource consumption data of current workloads of the plurality of DCs,
operate the trained prediction model based upon the current resource consumption data to generate predicted future resource consumption data for future workloads of the plurality of DCs,
receive a workload request, and
generate a recommended handling of the workload request based upon the predicted future resource consumption data.

14. The system of claim 13 wherein the processor is configured to generate the recommended handling based upon at least one of an allocated DC for the workload request, estimated revenues, a payment penalty for assignment to a DC different than the allocated DC, a constraint on a future workload allocation, a current capacity of each resource type at each DC, and resource costs.

15. The system of claim 13 wherein the trained prediction model comprises a time-series model, and wherein the historical resource consumption data comprises time-stamped workload consumption data for different workloads.

16. The system of claim 13 wherein the trained prediction model comprises a machine learning regression model, and the historical resource consumption data comprises metadata characterizing each workload.

17. A computer readable medium for cognitive handling of workload requests in a Cloud environment comprising a plurality of data centers (DCs), the computer readable medium comprising computer executable instructions that when executed by a processor cause the processor and associated memory to perform operations comprising:
obtaining historical resource consumption data of historical workloads of the plurality of DCs;
generating a trained prediction model based upon the historical resource consumption data;
obtaining current resource consumption data of current workloads of the plurality of DCs;
operating the trained prediction model based upon the current resource consumption data to generate predicted future resource consumption data for future workloads of the plurality of DCs;
receiving a workload request; and
generating a recommended handling of the workload request based upon the predicted future resource consumption data.

18. The computer readable medium of claim 17 wherein generating the recommended handling is based upon at least one of an allocated DC for the workload request, estimated revenues, a payment penalty for assignment to a DC different than the allocated DC, a constraint on a future workload allocation, a current capacity of each resource type at each DC, and resource costs.

19. The computer readable medium of claim 17 wherein the trained prediction model comprises a time-series model, and wherein the historical resource consumption data comprises time-stamped workload consumption data for different workloads.

20. The computer readable medium of claim 17 wherein the trained prediction model comprises a machine learning regression model, and the historical resource consumption data comprises metadata characterizing each workload.
